(19) United States
(12) Patent Application Publication
(10) Pub. No.: US 2026/0112869 A1
(43) Pub. Date: Apr. 23, 2026

(54) METHOD FOR REMOVING A CABLE FILM

(71) Applicant: Gebauer & Griller Kabelwerke Gesellschaft m.b.H., Wien (AT)

(72) Inventors: Daniel Rebel, Zistersdorf (AT); Bernhard Walker, Wien (AT); Jakob Manhart, Gießhübl (AT); Erich Habermann, Hermbaumgarten (AT); Stefan Veit, Ebenthal (AT); Arthur Weber, Zistersdorf (AT); Thibaut Lenormant, Wien (AT)

(21) Appl. No.: 19/427,631

(22) Filed: Dec. 19, 2025

Related U.S. Application Data
(63) Continuation of application No. 17/755,752.

(30) Foreign Application Priority Data
Nov. 8, 2019 (EP) 19207945.7

(51) Int. Cl. H02G 1/12

(52) U.S. Cl. CPC H02G 1/128; H02G 1/1282; H02G 1/1256

(57) ABSTRACT

A method for easy, safe and fast removal of a section of a cable film. An end section of a cable has a cable axis, wherein the cable includes a cable jacket and at least one electrically conductive conductor structure and which includes a cable film made from a plastic and applied into one of the conductor structures. A defined damaged region is generated by inductively heating at least that conductor structure on which the cable film is applied such that the cable film applied onto the heated conductor structure is at least partially thermally damaged in the damaged region. The cable film is moved relative to one of the conductor structures, wherein a crack is formed by the relative movement in the damaged region that separates the section of the cable film to be removed from a section of the cable film remaining on the cable.

### CROSS REFERENCE TO RELATED APPLICATIONS

This application is a continuation of U.S. patent application Ser. No. 17/755,752, filed May 6, 2022, which is a national stage filing based upon Patent Cooperation Treaty (PCT) Application No. PCT/EP2020/081210, filed Nov. 5, 2020, which claims the benefit of priority to European patent application No. 19207945.7, filed Nov. 8, 2019, the entire contents of each previous application being incorporated herein by reference.

### TECHNICAL FIELD

The present teaching relates to a method for removing a section of a cable film from an end section of a cable, wherein the cable comprises a cable jacket as well as at least one electrically conductive conductor structure and the cable film made of a plastic applied on one of the conductor structures and a processing device for carrying out the method. In light of the present application, the term electrically conductive conductor structure or conductor structure is defined as a, preferably metallic, structure suitable to conduct electrical current and in which circulating currents or eddy currents can be induced by means of an electrical field. Accordingly, the term conductor structure comprises both inner conductors, such as a solid conductor or a stranded conductor, as well as outer conductor structures, such as braided conductors or electrically conductive films, preferably metal films.

### BACKGROUND

In general, cables, in particular when they comprise an inner conductor as an inner conductor structure and one or more outer conductor structures, comprise one or more further insulation layers, wherein the outer insulation layer is referred to as a cable jacket. Between one of the conductor structures and the insulating layer located above it, a plastic cable film can be arranged that can act as mechanical protection, an electromagnetic shield, or as moisture protection. In particular on cables that comprise an inner conductor and a braided shield as an outer conductor structure, the cable film can be arranged between the braided shield and the cable jacket in order to allow the cable jacket to be stripped, since the cable jacket would otherwise become entangled with the braided shield located under the cable jacket without the cable film.

In order to expose the conductor structure located under the cable film so that the conductor structure can for example be contacted, special measures are required due to the low strength of the cable film compared to the cable jacket, inner conductor or other insulation layers, because simply cutting could damage a conductor structure located under the cable film, in particular a braided shield, and/or in particular an insulation layer located below the conductor structure.

In this context, the term end section of a cable is defined as the area of a cable that extends from one end along a cable axis at least over the region over which the conductor structures are exposed or will be exposed for contacting. This is also referred to as a contacting section or a stripped or to be stripped section of the cable. As a rule, the end section also comprises a section adjoining the stripped section of the cable over which the cable jacket is intact and that is preferably between 1 cm and 25 cm, particularly preferably between 5 cm and 15 cm, in length. The section of the cable film to be removed usually extends over a part of the end section of the cable, preferably starting at the cable end of the end section.

EP3444911A1 discloses a method for removing a cable film, wherein a section of the cable film to be processed is first exposed and this exposed section is subsequently subjected to a thermal, abrasive or chemical treatment in the area of an intended crack position. A heated form tool or a heating wire by which the cable film can be surface-melted or melted off is mentioned for the thermal treatment.

A first disadvantage of the prior art is that the cable jacket must be partially removed to remove the section of the cable film to be removed. Secondly, the proposed method requires a complicated device that either requires rotating the cable to achieve uniform heating or a heatable form tool specially adapted to the cable to be processed.

### SUMMARY

It is therefore a task of the present teaching to overcome the disadvantages of the prior art and to propose a method as well as a processing device that allows an easy, safe, and quick removal of a section of a cable film for end sections of cables with different diameters. A further task is to allow the cable film to be removed in sections without the need to expose the cable film prior to treatment.

This task is achieved by a method according to the present teaching for removing a section of a cable film to be removed from an end section of a cable having a cable axis, which comprises the following steps: provide an end section of a cable, wherein the cable comprises a cable jacket as well as at least one electrically conductive conductor structure and the cable film made of a plastic applied on one of the conductor structures; generate a defined damaged region by inductively heating at least the conductor structure on which the cable film is applied, so that the cable film applied to the heated conductor structure is at least partially thermally damaged in the damaged region; move the cable film relative to one of the conductor structures, preferably relative to an inner conductor, wherein a crack is formed by the relative movement in the damaged region that separates the section of the cable film to be removed from a remaining section of the cable film.

The section of the cable film to be removed from the cable is removed either directly by the relative movement, for example if the relative movement is already a stripping movement, or after the relative movement, preferably by stripping.

The solution according to the present teaching is characterized in that the controlled damage to the cable film in a defined damaged region is not caused by direct heat application, but in that the conductor structure located under the cable film is heated inductively and thus contactlessly. By introducing heat inductively, it is possible to generate the heat directly in the area where it is needed to pre-damage the cable film. Other areas of the cable, in particular the cable jacket, are not heated or at least not heated significantly. Furthermore, the heat introduction is completely contact-free, so that it is not necessary to remove the cable jacket in the damaged region before the heat treatment. Likewise, the contact-free heating has the effect that removing the cable film does not cause mechanical damage to the lower layer or layers. However, it is self-evident that the inductive heating can also be applied to an already exposed cable film.

A further advantage of the method according to the present teaching is that the inductive heating can simply heat the cable film in a precisely defined damaged region, wherein the damaged region of the cable film preferably extends over the entire circumference with respect to a cross-section of the cable, without the need for further manipulation of the cable.

In other words, the inductive heating, by means of which the conductor structure can be heated substantially uniformly in a defined area, generates thermal damage to the cable film along its entire circumference.

It should not be left unmentioned in this case that the induction parameters, such as the heating power and holding time, can be selected accordingly depending on the specific electrical resistance of the conductor structure in order to set the penetration depth and the temperature. Other parameters that can be used to influence the induction parameters are the frequency and amplitude of the alternating current flowing through the inductor, along with the geometric design of the inductor. The damaged region can be defined particularly precisely by setting the region in which the maximum temperature is reached.

The controlled thermal damage to the cable film in the damaged region determines the position on the cable where the cable film—and/or the conductor structure below if it is also to be removed as needed—forms a crack when it is stripped. The relative movement of the cable film in relation to one of the conductor structures, preferably in relation the conductor structure to be exposed, can be achieved by stripping off the cable film. During stripping, the cable film is either moved directly or by inter-positioning a further layer in the direction of the cable axis, i.e. in the direction of a front face of the end section, also called the cable end. However, it is also conceivable that the relative movement is a torsional movement or a bending movement that causes the crack to form. In a further step, the section defined by the crack can be removed from the cable, preferably by stripping. It is not mandatory that the steps of inductive heating and relative movement take place immediately in succession in the same processing space, because these steps can also be carried out in different processing spaces, such as inductive heating in a processing space of an induction unit and the relative movement in a further processing space of a jacket stripping device, physically separated from each other.

The term “thermally damaged” is understood to mean surface melting, melting through, or plasticizing the cable film as well as burning off, burning, embrittling, or degrading the cable film, wherein the type of thermal damage depends essentially on the material of the cable film as well as the duration and quantity of heat introduction. If the cable film is melted, partially melted, embrittled, or resolidified in the damaged region after the inductive heat treatment, the crack is formed in the cable film during the relative movement or during stripping. If the cable film is burned or burned off by the heating, the crack is already present prior to stripping and is only enlarged by the stripping.

For example, it is conceivable that a conductor structure designed as an inner conductor is heated by the inductive heating in order to at least partially melt a cable film applied on the inner conductor in the damaged region in order to be able to remove the cable film from the inner conductor.

It is also self-evident that the inductive heating of the conductor structure on which the cable film is applied can occur even if the cable comprises two or more conductor structures. There can also be an inductive heating of those conductor structures on which no cable film is applied. However, the low thickness of the cable film generates a defined damage in the area of the cable film, while other layers are generally not significantly influenced. Furthermore, the heating of those conductor structures on which no cable film is applied can be reduced by selecting suitable induction parameters, wherein the skin effect can in particular be taken advantage of at high frequencies.

The cable has a cable axis that represents the axis of symmetry with respect to a cross-section of the cable. It goes without saying that the cable axis is positioned normally in reference to the corresponding cross-section of the cable and can correspondingly also be curved when the cable is bent. As a rule, the end section of the cable is not bent, so that the cable axis is straight in the end section.

A further design variant of the present teaching provides that the at least one conductor structure consists of an inner conductor and at least one outer conductor structure, wherein the cable film is applied to one of the outer conductor structures. Preferably, the cable film is applied to the outer conductor structure with respect to the cable axis if more than one outer conductor structure is provided. However, it is also conceivable that the cable film is applied to an outer conductor structure located further inward, or on the inner conductor. Likewise, it is conceivable that a cable film is applied to several of the conductor structures. In all the aforementioned cases, it is advantageous if the processing takes place from the outside to the inside, whereby the different processing sections are generally stepped. It goes without saying that the cable film is applied to the outer conductor structure when only one outer conductor structure is present.

It can also be provided that in this case, even those conductor structures on which no cable film is applied can be heated by the inductive heating, whereby cumulative effects can be achieved if two outer conductor structures are arranged directly one above the other. For example, the at least one outer conductor structure can comprise a metal braiding, such as a braided shield, and/or a metal film, in particular consisting of a braided shield and/or a metal film. For example, it is conceivable that the cable film is in particular applied onto, or envelopes, the metal braiding, and is inductively heated by the braided shield, so that the cable film is at least partially thermally damaged.

A preferred design variant of the method according to the present teaching provides that the outer conductor structure on which the cable film is applied is formed as a metal film. Due to the relatively low thickness of the metal film, the latter can be heated particularly efficiently by adjusting the penetration depth of the inductive heating. The metal film is preferably an aluminum-based film or an aluminum film. Because the metal film has a low thickness and therefore generally a low tensile strength and/or shear strength and because the cable film is thermally damaged in the damaged region, so that the cable film likewise has no appreciable increasing influence on tensile and shear strength in the damaged region, the crack in the cable film also leads to crack formation of, or damage to, the metal film in the damaged region.

A combination of metallic film and cable film is often used in coaxial cables, which also have a braided shield for electromagnetic shielding as the outer conductor structure. A particularly preferred design variant can therefore provide that the at least one outer conductor structure comprises a braided shield and a metal film, wherein the metal film is arranged directly on the braided shield. The cable film is in turn applied directly onto the metal film. In this application, the inductive heating can lead to a cumulative heating effect of the braided shield and metal film, but the achievable heating of the outer conductor structure is generally in relation to the possible penetration depth, so that the metal film is heated more than the braided shield due to its lower thickness.

It is in particular preferred when the metal film and the cable film are formed as a composite film, especially when coaxial cables are used.

A further design variant of the present teaching provides that the outer conductor structure formed as a metal film is structurally weakened by the inductive heating in the damaged region. If the outer conductor structure on which the cable film is applied is designed as a metal film, it is advantageous if the metal film is removed together with the cable film. Accordingly, a propagation of the damaged region from the cable film to the metal film due to the structural weakening of the metal film results in a defined crack also formed in the metal film in the damaged region during stripping, so that the metal film and cable film can be removed together without leaving residue on the underlying layer that could interfere with any contacting.

At least the corresponding conductor structure can be heated inductively particularly easily when the inductive heating is carried out by means of an inductive coil, by means of which an electromagnetic alternating field is generated, wherein at least the damaged region to the cable is arranged within the inductive coil during the inductive heating. By generating an electromagnetic alternating field in a water-cooled induction coil, the frequency and amplitude of the alternating current flowing through the induction coil can be considered as relevant parameters for the inductive heating. By using an induction coil, the fully circumferential damage to the cable film can also be ensured in a particularly simple manner, since at least one area of the end section of the cable is arranged during heating in the induction coil and the corresponding conductor structure is accordingly heated uniformly over the entire circumference.

Finally, by using an induction coil into which the cable to be processed is introduced at least in sections, the inductive heating can be used for a plurality of different cable diameters or cable types as long as a required distance between the inner diameter of the induction coil and the outer diameter of the accommodated cable section is maintained, which distance can for example be formed as an air gap or can be filled with a non-conductive material. For this purpose, it is generally only necessary to adjust the parameters of the generated electromagnetic alternating field, preferably by setting the amplitude and frequency of the excitation current, or the penetration depth, the holding time and/or the heating power.

While it goes without saying that the inductive heating can also be applied to an already exposed cable film, it is advantageous if the heat treatment can be carried out without the cable jacket having to be removed in the damaged region. Accordingly, a further preferred embodiment of the present teaching provides that the cable film is covered by the cable jacket in the damaged region during inductive heating of the at least one conductor structure. In other words, the cable jacket is intact in the damaged region or in the section of the cable inserted into the induction coil, so that the cable film inside the cable is heated. This is only possible thanks to the inductive heating of the conductor structure below the cable film, since the inductive heating introduces the required heat directly where the heat is needed, and not from the outside. In other words, the conductor structure on which the cable film is applied is inductively heated through the cable jacket to produce the damaged region.

In order to enable processing of the cable jacket so that the cable jacket can be removed from a section of the cable end section to be stripped as part of the method, a further embodiment provides that the method further comprises the following step:
at least partially circumferential cutting of the cable jacket at a position that is arranged closer to a cable end of the end section of the cable, i.e. an end face of the end section, than the damaged region. Scoring the cable in a position that lies between the cable end, i.e. the front face of the end section of the cable, and the damaged region achieves that the location at which the cable film tears—or cable film and metal film tear, if applicable—is located below the cable jacket during stripping. Thus, after removal of the section of the cable jacket to be removed, any torn cable film residue that may be produced during tearing and remains on the conductor structure is covered by the remaining section of the cable jacket due to the offset between the cutting location and the damaged region.

The above-described positioning of the cut is particularly advantageous if the cable comprises three conductor structures, namely an inner conductor, a braided shield, and a metal film, wherein the braided shield, metal film and cable film are arranged directly one above the other in this order, and is therefore a coaxial cable. This is the case because any residual metal film and/or cable film remaining on the cable film could inhibit the contacting of the braided shield. The selection of the cutting position ensures that such residue of cable film and/or metal film on the braided shield remains concealed by the cable jacket, so that the actually exposed section of the braided shield is free of residue.

It is also conceivable that the cutting takes place before the inductive heating of the damaged region, if necessary before the end section is inserted into the processing space of a processing device, as is likewise conceivable that the cutting takes place during or after the inductive heat treatment of the damaged region.

For example, the cutting can take place in a further processing space of a cutting device. Finally, removing the cable jacket is not a necessary step for performing the heat treatment.

Although it is advantageous, as described above, that the distance between the position of the cut and the end of the cable is less than the distance between the damaged region and the end of the cable, it is of course also conceivable that the damaged region is arranged closer or equally close to the cable end than the cut, so that a section of the cable film is exposed as required after the cable jacket is stripped.

The cable film can be removed particularly simply by stripping the end section of the cable together with the cable jacket directly above it, since the cable film generally has a higher adhesive bond to the cable jacket. Thus, when the cable jacket is cut, preferably as described above, the cable jacket can be moved with corresponding means relative to one of the conductor structures, in particular relative to the inner conductor, wherein the cable film located under the inner conductor, or the cable film located under the inner conductor and/or the metal film located under the cable film, form a crack in the damaged region and can be stripped together with the cable jacket. The relative movement can in turn be a bending movement, a rotary movement, and/or a stripping movement, i.e. a movement in the direction of the cable axis towards the cable end of the end section. The combined removal of the section of the cable jacket to be removed and the section of the cable film to be removed is performed by stripping the section of the cable jacket to be removed. Therefore, a further design variant of the present teaching provides that an at least partially circumferential, preferably completely circumferential, cut divides the cable jacket into a section of the cable jacket to be removed and a remaining section of the cable jacket, and that the section of the cable jacket to be removed is moved in the direction of the cable axis, wherein the section of the cable film to be removed, which is at least partially attached to the cable jacket, is removed by the movement.

Although it is generally conceivable that the aforementioned process steps are carried out sequentially in different processing spaces, it is particularly advantageous if the corresponding steps are carried out in a processing space of a common processing device, which is described in detail below. A further embodiment of the present teaching therefore provides the steps: inductive heating at least of that conductor structure on which the cable film is applied; at least partial circumferential cutting of the cable jacket; combined removal of a section of the cable jacket and the section of the cable film to be removed, preferably by stripping; are performed in a processing space of a processing device, preferably in the specified order.

It has proven to be particularly advantageous that the cable film is heated to a temperature that is within a preferred temperature range, which temperature can be set by the temperature of the inductively heated conductor structure located under the cable film. A further embodiment therefore provides that the at least one conductor structure is inductively heated to a temperature of greater than or equal to 80° C., preferably greater than or equal to 100° C., particularly preferably greater than or equal to 200° C., particularly greater than or equal to 300° C. The temperature can be measured, for example, by means of a pyrometer. The temperature of the inductively heated conductor structure and the duration of the inductive heating, for example, less than 30 s, in particular less than 20 s, preferably less than 10 s, can be adjusted depending on the material properties of the cable film, for example the thickness and/or the type of plastic, in order to achieve the thermal damage.

The task mentioned at the outset is also solved by a processing device for carrying out the method according to the present teaching comprising: a processing space for accommodating an end section of a cable to be processed, wherein the cable comprises a cable jacket as well as at least one electrically conductive conductor structure and a cable film made of a plastic applied to one of the conductor structures; an induction coil arranged in the processing space, which induction coil is designed in order to inductively heat up at least that conductor structure of a section of the cable located in the inductive coil during a processing operation on which conductor structure the cable film is applied, such that the cable film applied to the heated conductor structure is at least partially thermally damaged in a damaged region; means for stripping a section of the cable film defined by the damaged area to be removed.

In addition to the advantages mentioned at the outset of the inductive heating of the at least one conductor structure to generate a damaged region in the cable film or, if necessary, in the cable film and the metal film below it, combining the inductive heat treatment and stripping of the cable film in a processing device reduces the number of the necessary manipulation operations and permits an efficient removal of the cable film. It is only necessary for a processing operation to insert the section of the cable to be processed into the induction coil. However, it is conceivable that the section of the cable film to be removed is not completely removed by the intended means, but is instead only partially removed.

The means for stripping the section of the cable film to be removed can be, for example, translationally movable gripping and/or moving elements that can directly grip the cable film and shift and/or twist it relative to a layer below the cable film, for example relative to an inner conductor or a braided shield.

It is conceivable that several movements in succession can be performed by the means of stripping, for example a twisting or bending movement to create a crack in the damaged region of the cable film and a subsequent linear stripping motion to remove the section of the cable film to be removed, if necessary together with a section of the cable jacket to be removed. It is also conceivable that the means for stripping are designed as a correspondingly formed cable film removal device.

However, as described in more detail below, it is not mandatory that the means for stripping the cable film directly contact the cable film. For example, the means for stripping the cable film can be formed as a cutting unit for producing a cut in the cable jacket that can also perform a relative movement in the direction of the cable axis after the cutting.

In other words, the means for stripping the cable film can be a device designed such that at least the section of the cable film to be removed can be moved, preferably together with a section of the cable jacket to be removed, relative to one of the conductor structures, preferably relative to a metal braiding or the inner conductor, so that a crack is formed at least in the cable film in the damaged region.

The means for stripping a section of the cable film, in particular if the processing device is designed as a system with several partial devices, do not necessarily have to be arranged in the same processing space where the induction coil is arranged.

For example, it is also conceivable that the means for stripping a section of the cable film are arranged in a further processing space of a stripping device of the processing device, preferably the equipment.

In principle, such a device can process the end sections of a cable in which the cable film was already exposed by the removal of the cable jacket and also the end sections of cables with an intact cable jacket, provided that either a cutting unit is arranged or the cable jacket has already been cut prior to insertion into the processing device.

It should also not be left unmentioned that an induction coil arranged to inductively heat a conductor structure, such that the cable film applied to the heated conductor structure in a damaged region is at least partially thermally damaged, is also generally suitable to thermally damage a non-metallic intermediate layer applied onto the heated conductor structure and not made of plastic. For example, such non-metallic intermediate layers can be woven structures, preferably impregnated with resins, and made from substances such as cotton or paper. Such non-metallic intermediate layers are usually designed to protect an outer conductor structure formed as metal film located underneath from tearing. A correspondingly designed induction coil can also be suitable to thermally damage an adhesive layer applied to the heated conductor structure.

A further embodiment of the present teaching provides that at least one clamping unit for fixing the end section of the cable during the processing operation is arranged in the processing space. The at least one clamping unit preferably comprises at least one clamping element, preferably made of plastic so that it can be positioned in close proximity to the induction coil.

The end section of the cable can be efficiently fixed by means of the clamping unit in order to enable both inductive heat treatment and relative movement of the cable film relative to one of the conductor structures, preferably relative to an inner conductor, without the cable moving relative to the processing space.

A further embodiment of the present teaching provides that the processing device further comprises a cutting unit for at least partially circumferentially cutting the cable jacket. Since the cable jacket does not have to be exposed to carry out the inductive heating of the at least one conductor structure in the damaged region, the cutting and, if necessary, the subsequent removal of the cable jacket can take place directly in the processing device, in particular if the means for stripping comprise the cutting unit. However, it is also conceivable that the processing device, in particular if the processing device is designed as a system with several partial devices, has a cutting device with a further processing space, wherein the cutting unit is arranged in the further processing space of the cutting device.

For example, the cutting unit can have at least one cutting element, preferably at least two, exactly two, or more cutting elements that penetrate in radial direction into the cable jacket during the cutting movement in order to generate an at least partially, preferably complete circumferential cut.

A preferred embodiment of the processing device according to the present teaching provides that the cutting unit is arranged in the processing space, wherein the processing space has an insertion opening for the cable and the induction coil is arranged between the cutting unit and the insertion opening.

Preferably, the cutting unit is arranged between the means for stripping and the induction coil. A corresponding arrangement of the cutting unit in the processing space that also accommodates the induction coil achieves that the partially circumferential cutting of the cable jacket is achieved in a position that is arranged closer to a cable end of the cable than the damaged region generated by the inductive heating of the corresponding conductor structure. Because the end section of the cable typically represents only a small section of the total length of the cable, an insertion opening for the cable in the processing space is typically provided, through which the section of the cable to be processed can be inserted into the processing space or through which the not processed section of the cable can be guided out of the processing space. In order to define for the end section of a cable to be processed in the processing device the position of the cut in the cable jacket relative to the damaged region in which the cable film or the cable film and metal film form a tear during stripping, the induction coil, which generates the damaged region, is arranged between the cutting unit and the insertion opening.

To allow easy removal of the portion of the cable film to be removed, which on the one hand does not require that the cable jacket in the damaged region must be removed before the inductive heating of the conductor structure, and, on the other hand, allows for particularly simple manipulation, a further embodiment of the present teaching provides that the means for stripping the section of the cable film to be removed are formed to contact a section of the cable jacket to be removed by a cut and to subsequently remove by means of a stripping movement the section of the cable jacket to be removed together with a section of the cable film to be removed, which preferably adheres to the cable jacket. The cut in the cable jacket can either be made with the aforementioned cutting unit or the cut can already be present in the inserted end section of the cable.

The means for removing the end section of the cable film can in turn be designed as grip elements or pushing elements, which however do not have to contact and grip the thin cable film, but the stronger cable jacket. The gripping and relative movements, e.g. pushing, pulling, twisting or bending, of the section of the cable jacket to be removed relative to one of the conductor structures, preferably relative to the inner conductor, causes the cable film located thereunder and at least partially attached to the cable jacket to also be tensioned, so that the cable film forms a crack in the damaged region and can subsequently be stripped. The stripping movement, which comprises a movement of the section of the cable jacket to be removed in the direction of the cable end, can either also be used simultaneously for crack generation or may occur only after crack generation with a previously performed relative movement. If the inductively heated conductor is a metal film, the crack can also form in the metal film, so that the metal film and cable film can be removed together with the section of the cable jacket to be stripped from the layer of the cable located thereunder, in particular from a braided shield, in order to expose this layer, in particular the braided shield.

A further embodiment of the present teaching provides that the means for stripping the section of the cable film to be removed and/or the cutting unit are arranged in the processing space. The arrangement of several components of the processing device in the processing space where the induction coil is arranged enables a particularly compact design that enables the execution of several process steps in one processing space. Therefore, the induction coil, the cutting unit, and the means for stripping the cable film are particularly preferably arranged in a common processing space.

Some embodiments provide a method for stripping a cable, including: providing the cable, the cable defining a longitudinal axis, having a cable end, and including a conductor core, a film disposed concentrically about the conductor core, and a jacket disposed concentrically about the film; cutting through the jacket at a first distance along the longitudinal axis from the cable end to produce a jacket end portion and a jacket remainder portion; damaging the film at a second distance along the longitudinal axis from the cable end to produce a film end portion, a damaged region, and a film remainder portion, the second distance being greater than the first distance to offset the damaged region from a jacket remainder end; and removing the jacket end portion and the film end portion from the conductor core.

In some embodiments, the film is thermally damaged.

In some embodiments, the conductor core is heated via electrical induction.

In some embodiments, damaging the film includes positioning an induction coil about the cable at the second distance.

In some embodiments, the film is heated to a temperature less than a jacket melting point.

In some embodiments, the temperature is no more than a film melting point.

In some embodiments, removing the jacket end portion and the film end portion from the conductor core includes pulling the jacket end portion and the film end portion away from the conductor core.

In some embodiments, cutting through the jacket includes circumferentially slicing the jacket to produce a circumferential incision between the jacket end portion and the jacket remainder portion, and pulling the jacket end portion and the film end portion away from the conductor core includes inserting a tool into the circumferential incision, and axially pulling the jacket end portion with the tool.

In some embodiments, the tool is a cutting unit, and the cutting unit produces the circumferential incision.

In some embodiments, the film end portion breaks away from the film remainder portion at the damaged region.

In some embodiments, the jacket remainder portion covers the film remainder portion and the damaged region.

In some embodiments, when the film end portion is removed, the jacket remainder portion conceals residue of the damaged region.

In some embodiments, damaging the film includes softening the film.

In some embodiments, the damaged region is between the film end portion and the film remainder portion.

In some embodiments, removing the jacket end portion and the film end portion from the conductor core includes one or more of rotating and bending the jacket end portion and the film end portion relative to the jacket remainder portion and the film remainder portion.

Some embodiments provide a cable stripping system, including a grip element, a clamping unit, a motion device, a cutting unit, and a heater. The clamping unit is opposite the grip element. The motion device is configured to rotate the grip element relative to the clamping unit about a rotational axis extending through the grip element and the clamping unit. The cutting unit is between the grip element and the clamping unit. The heater is between the clamping unit and the cutting unit, the heater being offset from the cutting unit along the rotational axis.

In some embodiments, the heater is an induction coil, and the rotational axis extends through the induction coil.

In some embodiments, the cutting unit includes a cutting element extending radially inwardly, and the cutting unit rotates about the rotational axis.

Some embodiments provide a method for removing insulation from an end of a cable, including: thermally damaging a film layer sheathing a conductor core of the cable at a first distance along the cable from the end to produce a film end portion; circumferentially slicing a jacket layer sheathing the film layer at a second distance along the cable from the end to produce a jacket end portion, the first distance being greater than and thus offset from the second distance; and removing the film end portion and the jacket end portion from the conductor core.

In some embodiments, thermally damaging the film layer includes heating the conductor core via electrical induction.

### BRIEF DESCRIPTION OF THE DRAWINGS

The present teaching is now explained in more detail with reference to design examples. The drawings are exemplary and while they are designed to illustrate the idea of the present teaching, they are in no way intended to narrow or even conclusively reproduce the idea of the present teaching.

FIGS. 1A to 1C illustrate the schematic sequence of the method according to the present teaching based on an end section of a first design example of a cable;

FIGS. 2A to 2C illustrate the schematic sequence of the method according to the present teaching based on the end section of a second design example of the cable;

FIGS. 3A to 3C illustrate the schematic sequence of the method according to the present teaching based on the end section of a third design example of the cable;

FIG. 4 illustrates an end section of the cable in a processing device;

FIG. 5 illustrates the end section of the cable in the processing device after the inductive heating;

FIG. 6 illustrates the end section of the cable after cutting;

FIG. 7 illustrates the end section of the cable in the processing device during stripping.

### DETAILED DESCRIPTION

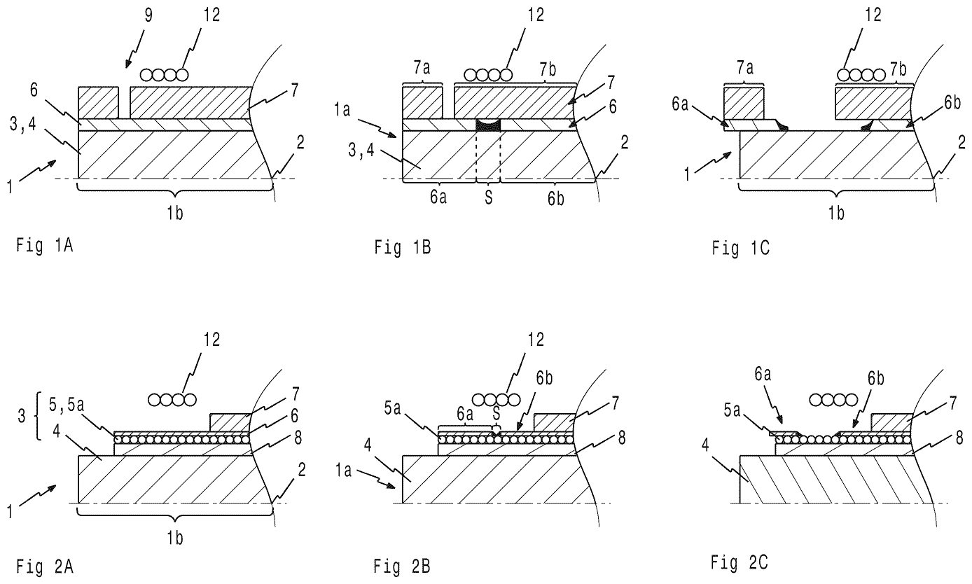

FIGS. 1A to 1C show steps of a method according to the present teaching using the example of a first design example of a cable 1. In the first design example, the cable 1 comprises a conductor structure 3 designed as an inner conductor 4 and an outer cable jacket 7, wherein a cable film 6, which is made of a plastic, is arranged between the inner conductor 4 and cable jacket 7. The cable film 6 is applied correspondingly to the conductor structure 3 embodied as an inner conductor 4. The cable 1 also has a cable axis 2, which represents a symmetry axis for the cable structure.

Here, an end section 1b of the cable 1 is shown, in which a section 6a of the cable film 6 to be removed from the inner conductor 4 is to be removed in order to expose a section of the inner conductor 4. The end section 1b of the cable 1 is arranged in sections within an induction coil 12 in order to be able to perform the inductive heat treatment described below.

In the present design example, as shown in FIG. 1A, cable jacket 7 already at the beginning of the procedure has a cut 9 in the end section 1b that divides the cable jacket 7 into a section 7a (see FIG. 1B) and a remaining section 7b.

FIG. 1B shows the end section 1b during or immediately after the inductive heat treatment by means of the induction coil 12. The inner conductor 4, i.e. the conductor structure 3 on which the cable film 6 is applied, is inductively heated using the induction coil 12. Due to the heating of the inner conductor 4 in a defined region, the cable film 6 is thermally damaged in an appropriately defined damaged region S.

The thermal damage can be, for example, a local surface melting, through-melting, or melting the plastic off the cable film 6 in the damaged region S, in particular if it is a thermoplastic. It is also conceivable that the plastic of the cable film 6 is burned off, degraded or embrittled in the damaged region S due to the thermal damage, in particular if it is a not a thermoplastic.

The thermal damage to the cable film 6 in the damaged region S defines an area where a crack forms during a movement of the cable film 6 relative to the inner conductor 4, said crack dividing the cable film 6 into a section 6a to be removed and a remaining section 6b.

Due to the crack defined by the damaged region S, the section 6a of the cable film 6 to be removed can be removed from the conductor structure 3 located thereunder, namely the inner conductor 4, without leaving any residue of the cable film 6 in the area of the inner conductor 4 to be exposed.

The end section 1b is delimited at one end by a cable end 1a, i.e. an end face of the cable 1. The end of the end section 1b opposite the cable end can coincide with the cut 9 and/or the damaged region S or can still comprise a section of the cable 1 where the remaining section 7a of the cable jacket 7 is arranged.

In the present design example, the cut 9 in the cable jacket 7 is arranged closer to the cable end 1a than the damaged region S, so that the cable jacket 7 is intact in that section of cable 1 located inside the induction coil 12 during the inductive heat treatment. Since the heat treatment takes place inductively, the damaged region S can be produced without the cable jacket 7 first having to be removed in the area to be processed. By offsetting the cut 9 and the damaged region S, it can be further achieved that any residue of the cable film 6 remaining on the inner conductor during stripping is concealed by the cable jacket 7, so that the insulated area of the inner conductor 4 is in any case free of plastic residue that inhibit contacting.

FIG. 1C shows the cable 1 during a stripping movement of the cable film 6, wherein a crack has already formed in the damaged region S, which has expanded or was enlarged by stripping, i.e. by the movement of the cable film 6 in the direction of the cable end 1a.

The present design example takes advantage of the fact that the cable film 6 usually adheres to the cable jacket 7 or that the bond between the cable jacket 7 and the cable film 6 is greater than between the cable film 6 and the conductor structure 3 located thereunder, here on the inner conductor 4. Accordingly, the section 7a of the cable jacket 7 to be removed and the section 6a of the cable film 6 to be removed are jointly removed by a common relative movement. This also allows for easier gripping of the cable film 6, since the cable jacket 7 can be gripped and moved by a corresponding stripping tool.

It should not be left unmentioned that the relative movement, which leads to the formation of the crack, does not (exclusively) necessarily have to be a translational movement, but can conceivably also be a rotary movement or a bending action. The removal of the sections 6a, 7a to be removed from the cable film 6 and cable jacket 7 after the crack formation is preferably done by means of a translational stripping movement in the direction of the cable end 1a.

After the removal of the sections 6a, 7a to be removed from the cable film 6 and cable jacket 7, a cable 1 remains in whose end area 1b the inner conductor 4 is exposed for contacting.

FIGS. 2A to 2C show the steps of the method according to the present teaching already discussed in connection with the first design example, which is why only the differences of the second design example are discussed in detail in comparison to the first design example.

While the cable 1 in the first design example comprises only a single conductor structure 3, namely the inner conductor 4, the cable 1 in the second design example comprises an inner conductor 4 and an outer conductor structure 5, namely a metal braiding 5a formed as a braided shield. The cable film 6 is not applied directly onto the inner conductor 4, but on the outer conductor structure 5, i.e. the metal braiding 5a. In order to prevent contacting between the metal braiding 5a and inner conductor 4, an inner insulation layer 8 is arranged between the inner conductor 4 and the metal braiding 5a.

Furthermore, it is discernible, in particular in FIG. 2B, that in the present design example, the section 7a of the cable jacket 7a to be removed was already removed before inserting the end section 1b into the induction coil 12. Although this is not necessarily required, as mentioned above, the inductive heating of the outer conductor structure 5 naturally also works if no section of the cable jacket 7 in the induction coil 12 is present between the conductor structure 3, 5, 5a to be heated and the induction coil 12. In the present design example, the penetration depth can be selected by means of the induction coil 12 by a corresponding selection of the induction parameters, such as amplitude and frequency of the induction current, such that the metal braiding 5a is heated in particular in the damaged region S, so that the cable film 6 located on the metal braiding 5a is thermally damaged in the damaged region S. In particular, it is advantageous if the insulating layer 8 has a higher thermal resistance than the cable film 6 in order to prevent the insulating layer 8 from being significantly thermally damaged in the damaged region S.

FIG. 2C shows that the section 6a of the cable film 6 to be removed is removed from the end section 1b by a relative movement of the cable film 6 to the metal braiding 5a.

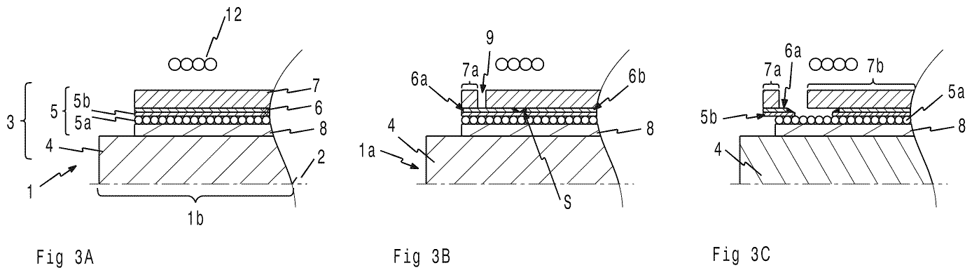

FIGS. 3A to 3C show the previously described steps of the method according to the present teaching in connection with a particularly preferred third embodiment. Once again, only the differences from the previously described design examples are addressed below.

In this design example, the cable 1 has three conductor structures 3, namely one inner conductor 4 and two outer conductor structures 5. As in the second design example, the first outer conductor structure 5a is a metal braiding 5a designed as a braided shield that is applied onto an insulating layer 8. On the metal braiding 5a, there is a second outer conductor structure in the form of a metal film 5b. In the present design example, the cable film 6 is applied onto the metal film 5b, wherein it is also conceivable that the metal film 5b and cable film 6 are formed as a composite film. This cable structure is a typical cable structure of a coaxial cable, wherein the metal braiding 5a acts as the braided shield.

In FIG. 3A, it can be seen that the cable jacket 7 is completely intact when inserting the end section 1b into the induction coil 12, and a cut 9 is therefore also not provided.

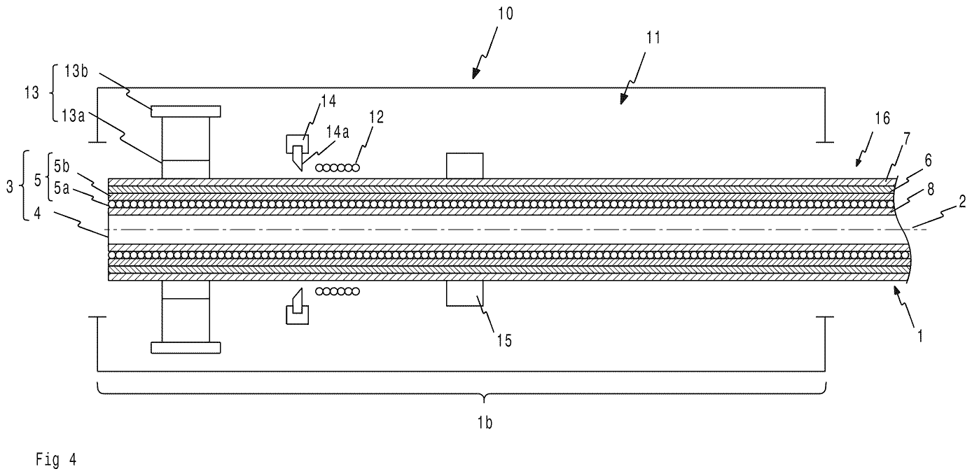

FIG. 3B shows that the cut 9 can be produced before, after, or during the inductive heating of the metal film 5b by means of the induction coil 12, but in the same processing device 10 (see FIGS. 4 to 6). In the present design example, the penetration depth can be selected by means of the induction coil 12 by a corresponding selection of the induction parameters, such as amplitude and frequency of the induction current, such that the metal film 5b is heated in particular in the damaged region S, so that the cable film 6 located on the metal film 5b is thermally damaged in the damaged region S.

Subsequently, as can be seen in FIG. 3C, the metal braiding 5a is exposed by removing from cable film 6 and cable jacket 7 the sections 6a, 7a to be removed. When moving cable jacket 7 and cable film 6 relative to the inner conductor 4 or to the metal braiding 5a, a crack is formed also in the metal film 5b in the damaged region S, so that the metal film 5b can also be removed together with cable jacket 7 and cable film 6 from the section to be exposed of the end section 1b of cable 1.

The combined removal can be achieved particularly easily with a composite film, but it is also conceivable that the tensile strength of the metal film 5b is reduced by the thermal damage to the cable film 6 such that a crack is formed in the metal film 5b during the relative movement due to the high adhesion between the cable film 6 and the metal film 5b.

It goes without saying that the above-described design examples, in particular with regard to the cable structures and the positions of the cuts 9, can be easily combined with one another. Additional layers, both insulating layers 8 and conductor structures, can also be provided, wherein the above-described exposure of inner conductors 4 and/or metal braids 5a can be repeated in stages with the above-described steps.

The operating principles of the method according to the present teaching will now be illustrated based on the processing device 10 shown in FIGS. 4 to 7. The processing device 10 in this case delimits a processing space 11, the processing space 11 accommodating an end section 1b of a cable 1 to be processed and having at least one insertion opening 16 for inserting the end section 1b. The structure of the cable 1 corresponds to the structure described in the context of FIGS. 3A to 3C, so that, the cable 1 comprises in the following order an inner conductor 4, an insulating layer 8, a metal braiding 5a designed as a braided shield, and a metal film 5b, a plastic film 6 applied on the metal film 5b, and a cable jacket 7.

The induction coil 12 is arranged in the processing space 11, wherein the end section 1b is guided through the induction coil 12, so that at least that section of cable 1 in which the damaged region S is to be generated is arranged inside the induction coil 12.

Furthermore, in order to fix the end section 1b of the cable 1, at least one clamping unit 15 is provided in the processing space 11 by means of which the end section 1b can be clamped during processing. The clamping unit 15 preferably comprises one or more clamping elements made of plastic, so that they can be positioned in the immediate proximity of the induction coil 12.

Furthermore, the processing device 10 comprises a cutting unit 14 with at least one cutting element 14a for producing a cut 9 in the cable jacket 7 and means 13 for stripping (a “stripper”) the section 6a of the cable film 6 to be removed. In the present design example, the means 13 for stripping comprise a grip element 13a that is designed to grip the cable jacket 7 or the cable film 6, as well as a motion device 13b by which the grip elements 13a can be moved relative to the cable 1, preferably shifted or twisted, as soon as they have circumferentially gripped the cable jacket 7 or the cable film 6.

FIG. 4 shows the first step of the method, namely the provision of an end section 1b of a cable 1, which has at least one conductor structure 3 and in which a plastic cable film 6 is applied onto one of the conductor structures 3. In the shown state of the processing device 10, the clamping unit 15 is already in a state of clamping the remaining section 7b of the cable jacket 7 and the grip elements 13a are engaged with the section 7a of the cable jacket 7 to be removed. The induction coil 12 is arranged in relation to the cable axis 2 between the means 13 for stripping the cable film 6 and the clamping unit 15 in order to fix the section of the cable 1 to be processed.

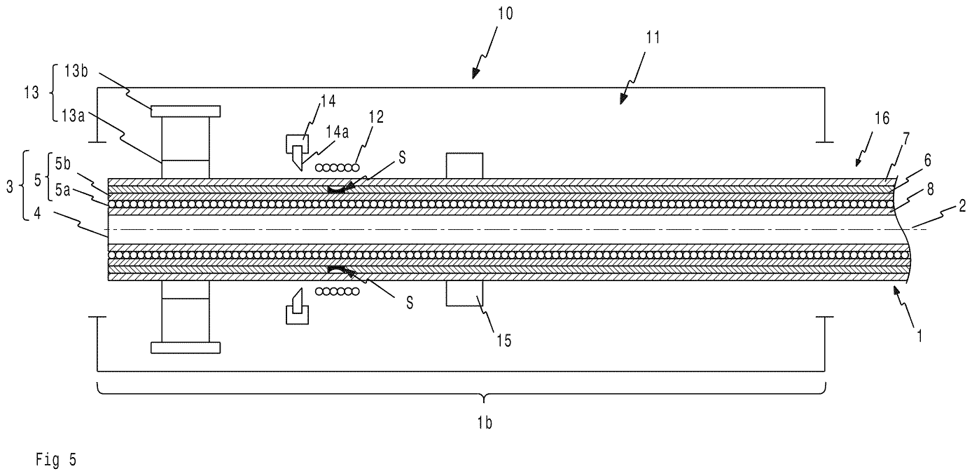

FIG. 5 now shows the step of generating the defined damaged region S by inductively heating the conductor structure 3, in the present case the metal film 5b, which is in contact with the cable film 6, by means of the induction coil 12 such that the cable film 6 is thermally damaged in the damaged region S. In order to achieve such a defined damage, the geometry of the preferably water-cooled induction coil 12 as well as the induction parameters, such as amplitude and frequency as well as heating duration, are selected such that an electromagnetic alternating field is generated in the induction coil 12, wherein a maximum heating of the metal film 5b is achieved by means of the penetration depth represented by the alternating field. Since the metal film 5b withstands a significantly higher thermal load due to the material properties than the plastic cable film 6 applied thereon, the cable film 6 is thermally damaged in the damaged region S by the inductive heating of the metal film 5b, for example melted or embrittled or degraded. In order to achieve such thermal damage, cable film 6 is brought to a temperature between 120° C. and 200° C. in the damaged region S by means of the inductively heated metal film 5b. The duration of the inductive heating is advantageously less than 20 s, preferably less than 10 s.

It is also conceivable in alternative design examples that the metal film 5b is designed to be structurally weakened by the inductive heating, so that a defined crack formation of the metal film 5b is achieved in the damaged region S.

Due to the inductive heating, the cable jacket 7 can be completely intact during the heating process, since the electromagnetic alternating field can penetrate the cable jacket 7 without this leading to heating or the penetration being impeded by the cable jacket 7. End sections 1b of cables 1 with different diameters and cable structure can also be processed by means of an induction coil 12, since only the parameters of the electromagnetic alternating field must be set accordingly.

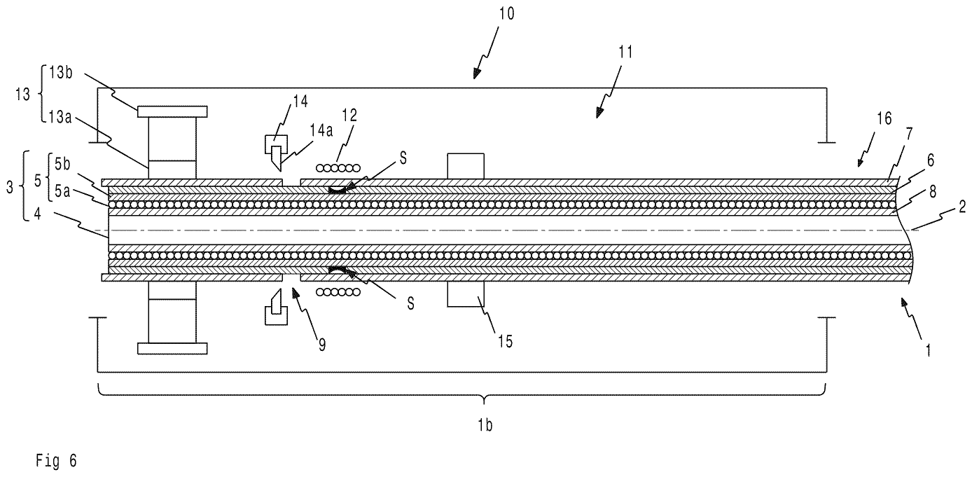

In FIG. 6, the end section 1b is shown after a cut 9 is produced in the cable jacket 7 by means of the cutting unit 14. Here, the cutting elements 14a penetrate into the cable jacket 7 in the radial direction, wherein the cutting elements 14a are designed to produce an at least partially, preferably completely circumferential cut 9. When the cutting unit 14 is movably held in the processing device 10, as shown, the section 7a of the cable jacket 7 to be removed can be shifted by means of the cutting unit 14 in the direction of the cable end 1a in order to enlarge the cut 9 in the axial direction.

The cutting unit 14 is arranged between the means 13 for stripping the cable film 6, in particular between the grip elements 13a, and the induction coil 12, so that the section between the cut 9 and the cable end 1a is smaller than the distance between the cable end 1a and the induction coil 12. From the vantage point of the insertion opening 16, the induction coil 12 is positioned between the insertion opening 16 and the cutting unit 14. A corresponding positioning of the cutting unit 14 ensures that any residue of the cable film 6 remaining during subsequent relative movement and stripping are concealed in the damaged region S by the remaining section 7b of the cable jacket 7 and thus do not negatively affect a contacting of the metal braiding 5a.

In alternative design variants of the method in which the cut 9 is made prior to the inductive heating, the described positioning of the cutting unit 14 ensures that the cable jacket 7 is intact in the region of cable 1 in which the damaged region S is generated by means of the induction coil 12.

As already mentioned in connection with the design examples shown in FIGS. 1A to 3C, the cutting unit 14 is not necessarily a required part of the processing device 10 because the cut 9 can also be produced before the end section 1b is inserted into the processing space 11 or the cable jacket 7 can be removed in the section to be processed prior to insertion.

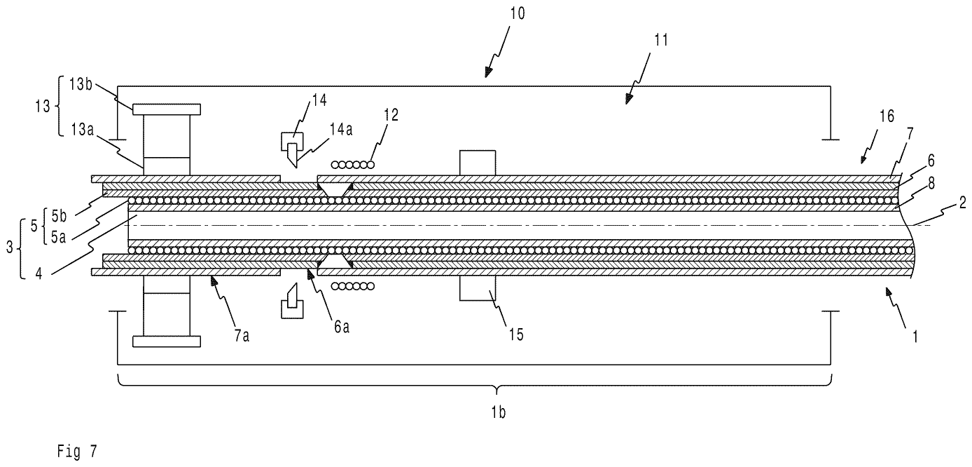

FIG. 7 shows the step of moving the cable film 6 relative to the conductor structures 3 remaining on cable 1, namely relative to the inner conductor 4 and to the metal braiding 5a. The relative movement, which can be a translational movement, a twisting movement, or a bending movement forms a crack in the damaged region S in the cable film 6, which separates the section 6a and the remaining section 6b of the cable film 6 from each other. Furthermore, a crack in the metal film 5b is also formed in the damaged region S, so that the metal film 5b can subsequently also be removed together with the sections 6a, 7a of cable film 6 and cable jacket 7 in order to expose the metal braiding 5a for contacting.

In the present design example, the movement of the grip elements 13a, which clamp the section 7a of the cable jacket 7 to be removed, also causes the section 6a of the cable film 6 adhering to the cable jacket 7, as well as the metal film 5b attached to the cable film 6, in particular when cable film 6 and metal film 5b are formed as a composite film, to be moved relative to the metal braiding 5a in order to form the crack. The crack will usually be formed based on the thermal damage to the cable film 6.

As soon as the crack in the damaged region S is formed in the metal film 5b and cable film 6, the removing sections 6a, 7a from cable film 6 and cable jacket 7, as well as from the metal film 5b, can be readily removed completely from cable 1, preferably by means of means 13 for stripping, in order to expose the metal braiding 5a formed as a braided shield.

It should not be left unmentioned that the above-described processing device 10 can accordingly also process cables with cable structures as shown in the above-detailed design examples, as well as cables with cable structures that have one or more intermediate layers.

Even if all relevant elements of the processing device 10 are for easier comprehension shown in FIGS. 4 to 7 arranged in a common processing space 11, which additionally causes a particularly short total duration for the removal of the section 6a of the cable film 6 to be removed, alternative design variants of the present teaching, in particular when the processing device 10 is designed as a system with several sub-devices, can provide that the cutting unit 14 and/or the means 13 for stripping the cable film 6 are each arranged in separate further processing spaces. For example, the cutting unit 14 can be arranged in a further processing space of a cutting device of the processing device 10 and/or the means 13 for stripping the cable film 6 can be arranged in a further processing space of a jacket stripping device of the processing device 10, while the induction coil 12 and preferably the damping unit 15 are arranged in the processing space 11. It should be understood that the steps recited in any of the method or process descriptions may be executed in any order and are not limited to the order presented. Further, in some embodiments, one or more of the steps recited in the method or process descriptions may omitted.

What is claimed is:

1. A method for stripping a cable, comprising:
providing the cable, the cable defining a longitudinal axis, having a cable end, and including
a conductor core,
a film disposed concentrically about the conductor core, and
a jacket disposed concentrically about the film;
cutting through the jacket at a first distance along the longitudinal axis from the cable end to produce a jacket end portion and a jacket remainder portion;
damaging the film at a second distance along the longitudinal axis from the cable end to produce a film end portion, a damaged region, and a film remainder portion, the second distance being greater than the first distance to offset the damaged region from a jacket remainder end; and
removing the jacket end portion and the film end portion from the conductor core.

2. The method of claim 1, wherein the film is thermally damaged.

3. The method of claim 2, wherein the conductor core is heated via electrical induction.

4. The method of claim 3, wherein damaging the film includes positioning an induction coil about the cable at the second distance.

5. The method of claim 2, wherein the film is heated to a temperature less than a jacket melting point.

6. The method of claim 5, wherein the temperature is no more than a film melting point.

7. The method of claim 1, wherein removing the jacket end portion and the film end portion from the conductor core includes pulling the jacket end portion and the film end portion away from the conductor core.

8. The method of claim 7, wherein
cutting through the jacket includes circumferentially slicing the jacket to produce a circumferential incision between the jacket end portion and the jacket remainder portion, and
pulling the jacket end portion and the film end portion away from the conductor core includes
inserting a tool into the circumferential incision, and
axially pulling the jacket end portion with the tool.

9. The method of claim 8, wherein
the tool is a cutting unit, and
the cutting unit produces the circumferential incision.

10. The method of claim 1, wherein the film end portion breaks away from the film remainder portion at the damaged region.

11. The method of claim 1, wherein the jacket remainder portion covers the film remainder portion and the damaged region.

12. The method of claim 11, wherein when the film end portion is removed, the jacket remainder portion conceals residue of the damaged region.

13. The method of claim 1, wherein damaging the film includes softening the film.

14. The method of claim 1, wherein the damaged region is between the film end portion and the film remainder portion.

15. The method of claim 1, wherein removing the jacket end portion and the film end portion from the conductor core includes one or more of rotating and bending the jacket end portion and the film end portion relative to the jacket remainder portion and the film remainder portion.

16. A cable stripping system, comprising:
a grip element;
a clamping unit opposite the grip element;
a motion device configured to rotate the grip element relative to the clamping unit about a rotational axis extending through the grip element and the clamping unit;
a cutting unit between the grip element and the clamping unit; and
a heater between the clamping unit and the cutting unit, the heater being offset from the cutting unit along the rotational axis.

17. The cable stripping system of claim 16, wherein
the heater is an induction coil, and
the rotational axis extends through the induction coil.

18. The cable stripping system of claim 16, wherein
the cutting unit includes a cutting element extending radially inwardly, and
the cutting unit rotates about the rotational axis.

19. A method for removing insulation from an end of a cable, comprising:
thermally damaging a film layer sheathing a conductor core of the cable at a first distance along the cable from the end to produce a film end portion;
circumferentially slicing a jacket layer sheathing the film layer at a second distance along the cable from the end to produce a jacket end portion, the first distance being greater than and thus offset from the second distance; and
removing the film end portion and the jacket end portion from the conductor core.

20. The method of claim 19, wherein thermally damaging the film layer includes heating the conductor core via electrical induction.
